(19) United States
(12) Patent Application Publication
(10) Pub. No.: US 2009/0202202 A1
(43) Pub. Date: Aug. 13, 2009

(54) FIBER LENS WITH FRESNEL ZONE PLATE LENS AND METHOD FOR PRODUCING THE SAME

(75) Inventors: Byeong Ha Lee, Buk-gu (KR); Kyunghwan Oh, Seongnam-si (KR); Jun Ki Kim, Buk-gu (KR); Hae Young Choi, Buk-gu (KR); Youngmin Jung, Buk-gu (KR); Ik-Bu Sohn, Gwangsan-gu (KR); Young-Chui Noh, Buk-gu (KR); Jongmin Lee, Buk-gu (KR)

Correspondence Address: OCCHIUTI ROHLICEK & TSAO, LLP, 10 FAWCETT STREET, CAMBRIDGE, MA, 02138, US

(73) Assignee: Gwangju Institute of Science and Technology, Buk-gu (KR)

(21) Appl. No.: 12/368,641

(22) Filed: Feb. 10, 2009

(30) Foreign Application Priority Data
Feb. 11, 2008 (KR) 10-2008-0012389

(51) Int. Cl. G02B 6/32; B32B 37/00; B29D 11/00

(52) U.S. Cl. 385/33; 156/250; 216/26

(57) ABSTRACT

A Fresnel lens-integrated optical fiber that can be easily aligned and manufactured in miniature, and a method of fabricating the same are provided. The Fresnel lens-integrated optical fiber includes a light transmission section transmitting incident light, a light expansion section coupled to the light transmission section and expanding light provided from the light transmission section, and a Fresnel lens surface formed on a section of the light expansion section and focusing by passing through the light expanded in the light expansion section at a predetermined focal length. Accordingly, since the Fresnel lens surface has no curvature, arrangement of an optical coupling system is easy, manufacture is easy, and the optical coupling system can be miniaturized.

### CROSS-REFERENCE TO RELATED APPLICATION

This application claims the benefit of Korean Patent Application No. 2008-0012389, filed on Feb. 11, 2008, the disclosure of which is hereby incorporated herein by reference in its entirety.

### BACKGROUND OF THE INVENTION

1. Field of the Invention

The present invention relates to an optical device, and more particularly, to a Fresnel lens-integrated optical fiber that can increase optical coupling efficiency in free space and can be easily manufactured, and a method of fabricating the same.

2. Description of the Related Art

Optical fiber lenses are used in the field of optical communications to increase optical coupling efficiency in free space when a light source and an optical fiber, an optical device and an optical fiber, or two optical fibers are coupled, and to manufacture a miniature optical coupling module. Recently, the optical fiber lenses are widely utilized in the field of biology such as optical imaging systems and optical trap beyond the field of optical communications.

Ordinary methods of fabricating an optical fiber lens include a method of forming a wedge-shaped or hemispherical lens shape by laser-processing or etching a longitudinal section of a single mode optical fiber, and a method of connecting bulk devices such as cylindrical gradient-index (GRIN) lenses or ball lenses between optical devices.

However, in the method of fabricating an optical fiber lens by processing a longitudinal section of a single mode optical fiber, since a lens function is exhibited only in a region corresponding to a core diameter of the single mode optical fiber (for example, 6 to 9 μm), a working distance is very short. Also, in the method of connecting bulk devices like GRIN lenses or ball lenses between optical devices, while excellent optical coupling efficiency can be obtained when a large aperture lens is used, since a lens with a larger aperture than an optical fiber has to be located between optical fibers, installation of an optical coupler is not easy and overall size of an optical coupling system increases.

To compensate for these drawbacks, different optical fibers having optical expansion sections such as GRIN lenses or silica optical fibers are directly joined to the single mode optical fiber using an optical fiber fusion splicer for fabricating a hybrid coupling fiber lens, and longitudinal sections of the different optical fibers are processed into lens shapes having a predetermined curvature through laser processing, etching, polishing, etc. Alternatively, the hybrid coupling fiber lens could be formed by depositing polymer on the longitudinal sections of the different optical fibers and then irradiating the polymer with ultraviolet radiation.

However, in such a hybrid coupling fiber lens, it is difficult to form lenses having precise curvatures on longitudinal sections of the different optical fibers, and minute arrangement and integration of optical devices are not easy due to curvature of the lenses.

### SUMMARY OF THE INVENTION

The present invention is directed to a Fresnel lens-integrated optical fiber that can be easily arranged and manufactured in miniature.

The present invention is also directed to a method of fabricating a Fresnel lens-integrated optical fiber that can be easily arranged, manufactured in miniature, and manufactured easily.

According to an exemplary embodiment of the present invention, a Fresnel lens-integrated optical fiber includes: a light transmission section transmitting incident light; a light expansion section coupled to the light transmission section and expanding light provided from the light transmission section; and a Fresnel lens surface formed on a section of the light expansion section and focusing by passing through the light expanded in the light expansion section at a predetermined focal length. The light transmission section may be composed of any one optical fiber selected from a single mode optical fiber, a multi mode optical fiber, a photonic crystal optical fiber, and a hollow optical fiber. The light expansion section may be composed of any one optical fiber selected from a coreless silica fiber, a GRIN fiber, and a photonic crystal optical fiber with air holes removed. The light transmission section and the light expansion section may be joined by fusion splicing. The Fresnel lens surface may be formed in the shape of a Fresnel zone plate composed of odd-numbered and even-numbered zones, and the even-numbered zones may be depressed surfaces formed by femtosecond laser-processing or etching the section of the light expansion section. The diameter of the light expansion section may be formed the same as or larger than the diameter of the light transmission section.

According to another exemplary embodiment of the present invention, a method of fabricating a Fresnel lens-integrated optical fiber includes: joining a first optical fiber constituting a light transmission section and a second optical fiber constituting a light expansion section; cutting the second optical fiber constituting the light expansion section into a predetermined length; and forming a Fresnel zone plate shape at a section of the second optical fiber. In joining the first optical fiber and the second optical fiber, one section of the first optical fiber may be joined to one section of the second optical fiber by fusion splicing using arc discharge or a CO₂ laser. In cutting the second optical fiber, the second optical fiber may be cut into a length so that the light expanded in the second optical fiber is not incident on and reflected from the inner circumference of the second optical fiber. In forming the Fresnel lens surface, at least one depressed surface, each having a different radius, may be formed on the section of the light expansion section. The at least one depressed surface may be formed by a femtosecond laser or etching. The first optical fiber may be composed of any one optical fiber selected from a single mode optical fiber, a multi mode optical fiber, a photonic crystal optical fiber, and a hollow optical fiber. The second optical fiber may be composed of any one optical fiber selected from a coreless silica fiber, a GRIN fiber, and a photonic crystal optical fiber with air holes removed.

### BRIEF DESCRIPTION OF THE DRAWINGS

These and/or other objects, aspects and advantages of the invention will become apparent and more readily appreciated from the following description of the exemplary embodiments, taken in conjunction with the accompanying drawings of which:

FIG. 1 is a schematic view showing the structure of a Fresnel lens-integrated optical fiber according to an exemplary embodiment of the present invention;

FIG. 2 is a front view showing the detailed shape of a Fresnel lens surface illustrated in FIG. 1;

FIG. 3 is a cross-sectional view of the Fresnel lens surface illustrated in FIG. 2;

FIG. 4 illustrates an example of use of the Fresnel lens-integrated optical fiber illustrated in FIG. 1;

FIG. 5 illustrates a method of fabricating a Fresnel lens-integrated optical fiber according to an exemplary embodiment of the present invention;

FIG. 6 lists a zone number and radius of each zone of a Fresnel zone plate corresponding to a predetermined wavelength and focal length;

FIG. 7 is a schematic view showing the packaging structure of a Fresnel lens-integrated optical fiber according to an exemplary embodiment of the present invention; and

FIG. 8 is a graph showing results of measuring working distance of a Fresnel lens-integrated optical fiber according to an exemplary embodiment of the present invention.

### DETAILED DESCRIPTION OF EXEMPLARY EMBODIMENTS

The present invention will now be described more fully hereinafter with reference to the accompanying drawings, in which exemplary embodiments of the invention are shown. This invention may, however, be embodied in many different forms and should not be construed as limited to the exemplary embodiments set forth herein. Whenever elements appear in the drawings or are mentioned in the specification, they are always denoted by the same reference numerals.

It will be understood that, although the terms first, second, A, B, etc. may be used herein to denote various elements, these elements are not limited by these terms. These terms are only used to distinguish one element from another. For example, a first element could be termed a second element, and, similarly, a second element could be termed a first element, without departing from the scope of the exemplary embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, numbers, steps, operations, elements and/or components, but do not preclude the presence or addition of one or more other features, numbers, steps, operations, elements, components and/or groups thereof.

Unless otherwise defined, all terms (including technical and scientific terms) used herein have the same meanings as commonly understood by one of ordinary skill in the art to which this invention pertains. It will be further understood that terms defined in common dictionaries should be interpreted within the context of the relevant art and not in an idealized or overly formal sense unless expressly so defined herein.

In the following description of exemplary embodiments of the present invention, the terms Fresnel lens surface and Fresnel lens mean the same thing. That is, Fresnel lens surface means a longitudinal section of a coreless silica fiber at which a Fresnel lens is formed.

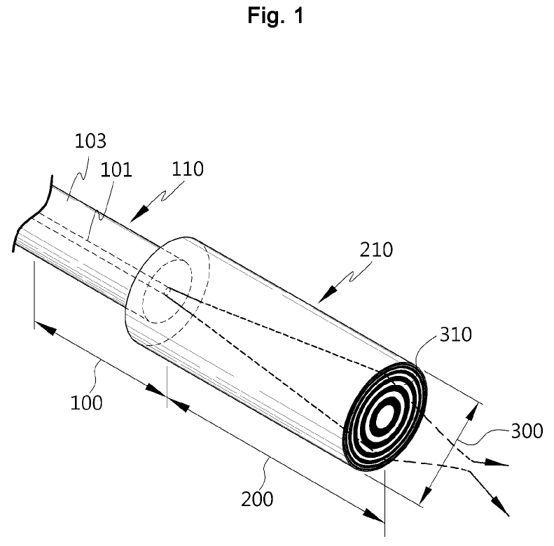

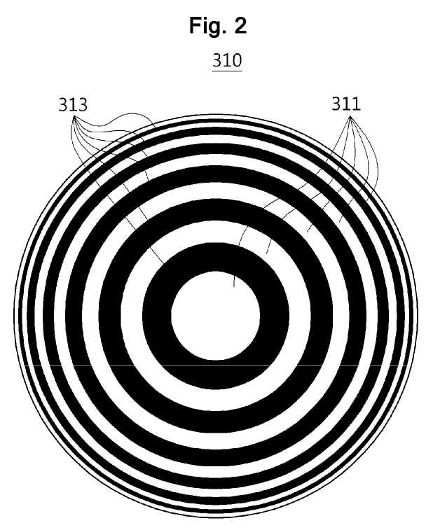

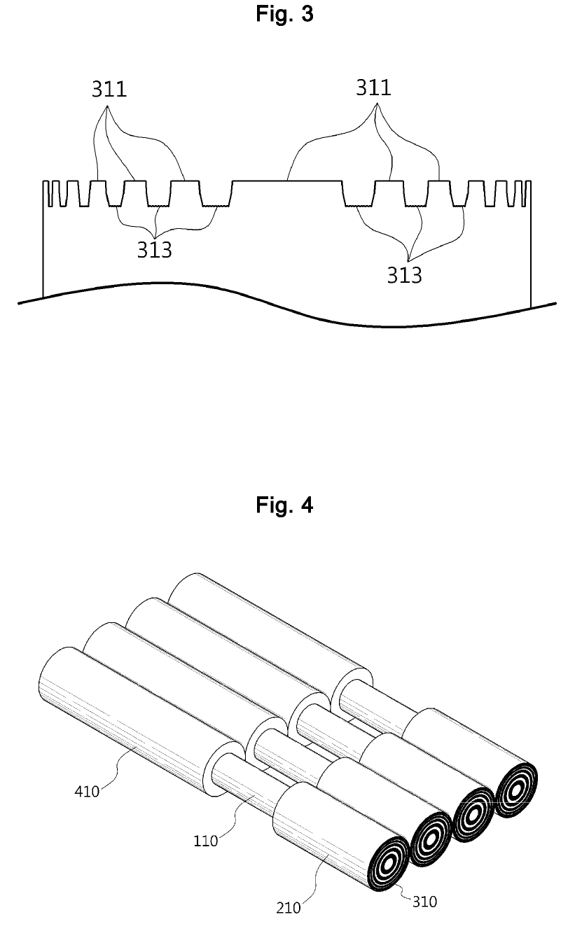

FIG. 1 is a schematic view showing the structure of a Fresnel lens-integrated optical fiber according to an exemplary embodiment of the present invention. FIG. 2 is a front view showing the detailed shape of a Fresnel lens surface illustrated in FIG. 1. FIG. 3 is a cross-sectional view of the Fresnel lens surface illustrated in FIG. 2.

Referring to FIGS. 1 to 3, a Fresnel lens-integrated optical fiber according to an exemplary embodiment of the present invention includes a light transmission section 100, a light expansion section 200, and a light focusing section 300.

The light transmission section 100, into which light emitted by a light source or transferred through various optical devices enters and propagates, may employ a single mode optical fiber, a multi mode optical fiber, a photonic crystal optical fiber, or a hollow optical fiber, etc.

In the following description of exemplary embodiments of the present invention, the case of the light transmission section 100 using a single mode optical fiber 110 is taken as an example. The single mode optical fiber 110 is composed of a core 101 having a diameter of several μm and a cladding 103 surrounding the core 101.

The light expansion section 200 expands light propagating through the core 101 of the single mode optical fiber 110 and reaching the light focusing section 300, i.e., a Fresnel lens surface 310, so that it may have sufficient size.

The light expansion section 200, for example, may be formed by coupling a coreless silica fiber (or a coreless silica rod), or a GRIN optical fiber, etc. to the single mode optical fiber 110. Also, the optical expansion section 200 may be formed by coupling a photonic crystal optical fiber whose plurality of air holes have been removed by heat to the single mode optical fiber 110. In the following description of exemplary embodiments of the present invention, the case of the coreless silica fiber 210 being used for the light expansion section 200 is taken as an example.

In the coreless silica fiber 210, since all parts of the optical fiber have the same index of refraction as ordinary silica, when light propagating from the single mode optical fiber 110 goes through the coreless silica fiber 210, it spreads by a predetermined angle and thus is expanded.

The light focusing section 300, which focuses light expanded through the light expansion section 200, is processed into a Fresnel zone plate by microprocessing a section of the coreless silica fiber 210 using a laser or performing an etching process on the section of the coreless silica fiber 210, etc. Thus, the light focusing section 300 is processed to have the effect of a Fresnel lens. That is, the light focusing section 300 means the Fresnel lens surface 310 formed on a longitudinal section of the coreless silica fiber 210.

As shown in FIGS. 2 and 3, the Fresnel lens surface 310 is composed of a protruding surface 311 and a depressed surface 313. The protruding surface 311 is a section of the coreless silica fiber 210, and the depressed surface 313 is a part of the section of the coreless silica fiber 210 that is engraved using a femtosecond laser. Here, at the processed section of the depressed surface 313, microscopic prominences and depressions are formed irregularly, dispersing light and obstructing its transmission.

The power of light emitted from the section of the coreless silica fiber 210 has a Gaussian distribution that is the highest in a center region and decreases toward the tip of the section. Accordingly, in an exemplary embodiment of the present invention, as shown in FIGS. 2 and 3, odd numbered zones of the Fresnel zone plate are formed by the section of the coreless silica fiber, that is, the protruding surfaces 311, and even numbered zones are formed by the depressed surfaces 313 processed by a femtosecond laser. Thus, in the depressed surfaces 313, light expanded in the coreless silica fiber 210 is dispersed and prevented from propagating so that the Fresnel lens surface 310 has the effect of a Fresnel lens.

The operation principles of the Fresnel lens-integrated optical fiber according to an exemplary embodiment of the present invention will now be described with reference to FIGS. 1 to 3. First, light provided from a light source or various optical devices is incident on the single mode optical fiber 110, propagates through the core 101 of the single mode optical fiber 110, is transferred to the coreless silica fiber 210 where it is expanded by a predetermined angle, and is transmitted through the Fresnel lens surface 310 formed on the section of the coreless silica fiber 210. Then, the light is focused into one spot at a characteristic focal length of the Fresnel lens-integrated optical fiber.

Here, the characteristic focal length may be adjusted depending on the length and diameter of the coreless silica fiber 210 and the shape of the Fresnel zone plate formed on the Fresnel lens surface.

FIG. 4 illustrates an example of use of the Fresnel lens-integrated optical fiber according to the present invention shown in FIG. 1.

FIG. 4 shows an example in which four Fresnel lens-integrated optical fibers like the one shown in FIG. 1 are arranged to form one ribbon-type optical cable.

FIG. 4 shows an example of a four-channel optical cable in which four Fresnel lens-integrated optical fibers are arranged, each Fresnel lens-integrated optical fiber is the same as that shown in FIG. 1, and each is wrapped in a jacket 410.

While FIG. 4 shows an example of a four-channel optical cable, it is clear that various channel ribbon-type optical cables (for example, 2-channel, 8-channel, 12-channel, 16-channel, etc.) can be constituted as needed by arranging various numbers of Fresnel lens-integrated optical fibers.

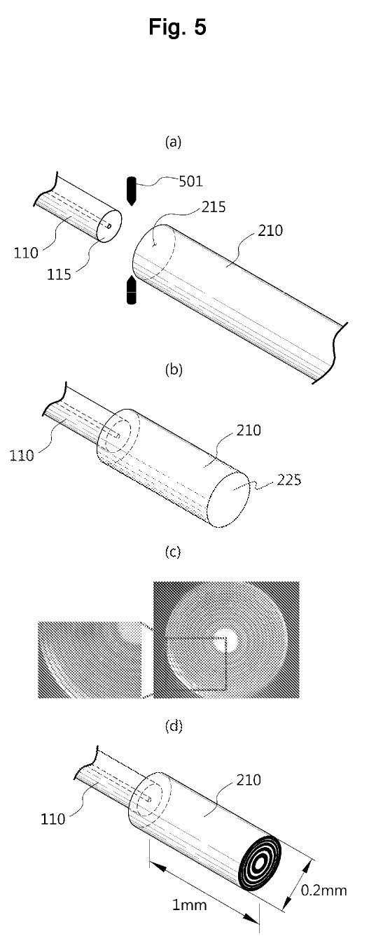

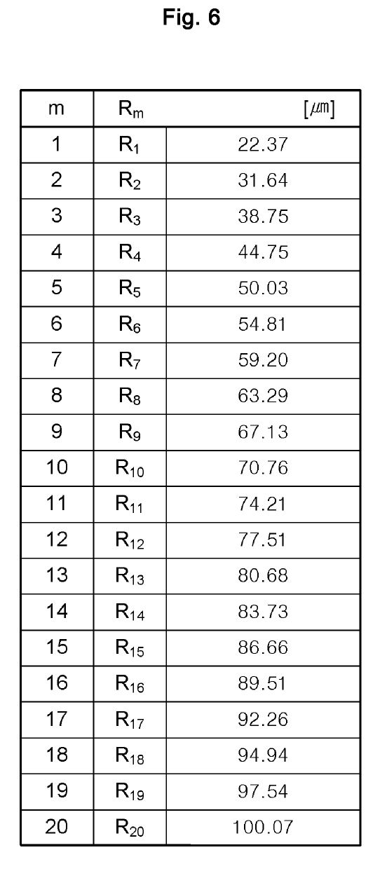

FIG. 5 illustrates a method of fabricating a Fresnel lens-integrated optical fiber according to an exemplary embodiment of the present invention, and FIG. 6 lists the zone number and radius of each zone of a Fresnel zone plate corresponding to a predetermined wavelength and focal length.

Referring to FIGS. 5 and 6, first, an optical fiber joining process of joining the ordinary single mode optical fiber 110 and the coreless silica fiber 210 is performed (a of FIG. 5). Here, it is preferable for the coreless silica fiber 210 to have a larger diameter than the single mode optical fiber 110 in order to enable light transferred from the single mode optical fiber 110 to expand to a sufficient size.

In joining the single mode optical fiber 110 and the coreless silica fiber 210, fusion splicing may be used.

Specifically, the single mode optical fiber 110 and the coreless silica fiber 210 are joined by inducing arc discharge through an electrode 501 between a section 115 of the single mode optical fiber 110 and a section 215 of the coreless silica fiber 210 facing the section 115 for thermal melting, and then adhering together the sections 115 and 215 to form one body.

The optical fiber joining process may also be performed using a CO₂ laser instead of the above-described arc discharge.

When the process of joining the single mode optical fiber 110 and the coreless silica fiber 210 is finished, a cutting process of cutting the coreless silica fiber 210 into a predetermined length is performed (b of FIG. 5).

If the coreless silica fiber 210 is unnecessarily long, light expanding by a predetermined angle inside of the coreless silica fiber 210 is incident on the inner circumference of the coreless silica fiber 210 and reflected, causing interference with light propagating forward. Accordingly, in the cutting process, an unnecessary part of the coreless silica fiber 110 is cut away leaving only a length from the surface joined with the single mode optical fiber 110 that enables light to optimally expand without causing such interference. Here, a section 225 of the coreless silica fiber 210 is formed to be perpendicular to the optical axis and perfectly planar.

Next, a process of forming a Fresnel zone plate at the section 225 of the coreless silica fiber 210 cut in the cutting process is performed (c of FIG. 5).

The Fresnel zone plate may be processed by a femtosecond laser or etching. The focal length of light emitted through the Fresnel lens surface 310 can be set by adjusting radii of zones forming the Fresnel zone plate and the diameter and length of the coreless silica fiber.

Equation 1 shows the relationship between wavelength of light passing through the Fresnel lens surface, focal length, and diameter and length of the coreless silica fiber. Equation 1 can be used to determine the shape of the Fresnel zone plate required to attain a certain desired focal length for a given wavelength of light.

$$\{ \frac{1}{{ρ}_{0}} + \frac{1}{{r}_{0}} \} = \frac{m λ}{{R}_{m}^{2}} \qquad < Equation 1 >$$

In Equation 1, ρ₀ denotes a distance from the center of the interface between the single mode optical fiber and the coreless silica fiber to the center of the Fresnel zone plate, i.e., the length of the coreless silica fiber, r₀ denotes a distance from the center of the Fresnel zone plate to the focus, m denotes a zone number of the Fresnel zone plate, λ denotes a wavelength, and Rₘ denotes a radius of the m^{th} zone.

For example, when the wavelength λ of light passing through the Fresnel lens surface 310 is 1550 nm, the focal length r₀ is 600 μm, the diameter of the coreless silica fiber 210 is 200 μm, and the length ρ₀ is 700 μm, the numbers and radii of the respective zones of the Fresnel zone plate obtained using Equation 1 are as shown in FIG. 6.

As shown in FIG. 6, when the diameter of the coreless silica fiber is 200 μm, since the radius R₂₀ of the 20^{th} zone given by Equation 1 exceeds 100 μm, the 20^{th} zone cannot be formed and the Fresnel zone plate is only formed up to a 19^{th} plate.

FIG. 5 (c) shows a microphotograph of the Fresnel lens surface 310 formed on the section 225 of the coreless silica fiber 210 using a femtosecond laser.

Specifically, the Fresnel zone plate was processed using a femtosecond laser having a wavelength of 785.5 nm, a pulse width of 184 fs, a pulse amplitude of 0.45 μJ, and a pulse repetition period of 1 kHz.

FIG. 5 (d) is a schematic view showing a Fresnel lens-integrated optical fiber fabricated by the process described with reference to FIG. 5 (a) through (c), in which the diameter of the coreless silica fiber 210 is 0.2 mm, and length, diameter and external diameter are 1 mm.

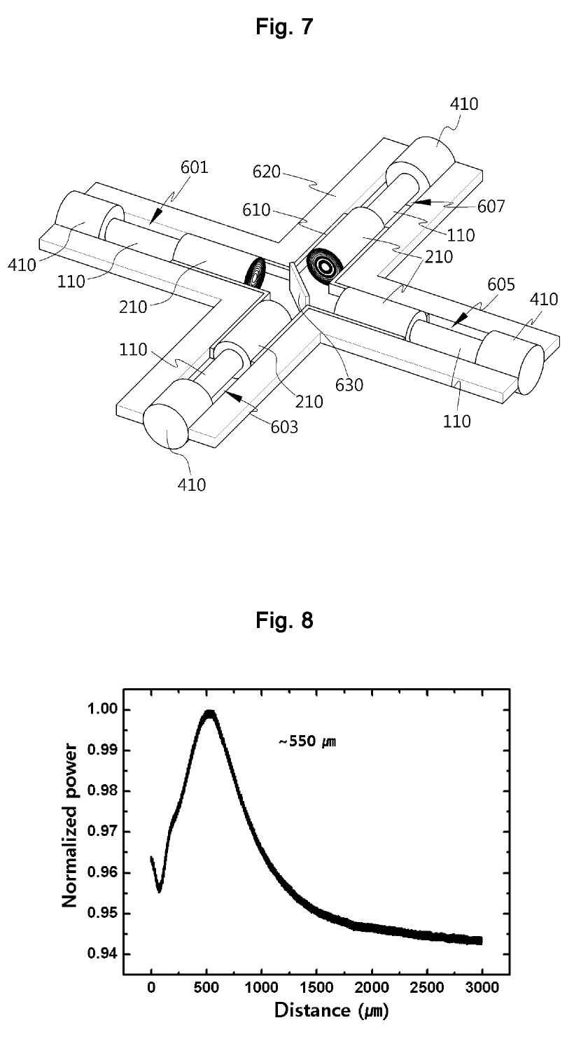

FIG. 7 is a schematic view showing the packaging structure of a Fresnel lens-integrated optical fiber according to an exemplary embodiment of the present invention.

Referring to FIG. 7, a Fresnel lens-integrated optical fiber package according to an exemplary embodiment of the present invention has a structure in which a plurality of Fresnel lens-integrated optical fibers 601 to 607 are fixed to a first fixing member 610 and a second fixing member 620 for packaging.

Each of the plurality of Fresnel lens-integrated optical fibers 601 to 607 is the same as that illustrated in FIG. 1, and a jacket 410 is installed at the outer circumference of the single mode optical fiber 110 of the Fresnel lens-integrated optical fiber to protect the single mode optical fiber 110 exposed to the outside of the packaging from the outside environment.

Also, the plurality of Fresnel lens-integrated optical fibers 601 to 607 are arranged 90 degrees apart so that their Fresnel lens surfaces 310 all face a center area. Also, between the Fresnel lens surfaces of the Fresnel lens-integrated optical fibers, a micro electro mechanical system (MEMS)-based mirror 630 is installed for optical switching.

The first fixing member 610 fixes the coreless silica fiber 210 of each of the Fresnel lens-integrated optical fibers 601 to 607 and prevents the coreless silica fiber 210 from moving due to the outside environment. Thus, the first fixing member 610 prevents the arrangement of the optical fibers from changing and simultaneously prevents optical switching loss. Here, the first fixing member 610 may be formed to the same thickness as the difference in diameter between the jacket 410 and the coreless silica fiber 210.

Also, the second fixing member 620 fixes the outer circumference of the first fixing member 610 and the jacket 410, prevents the arrangement of the Fresnel lens-integrated optical fibers from changing, and protects the single mode optical fiber 110 exposed by the jacket 410 and the coreless silica fiber 210 from the outside environment. Here, the first fixing member 610 and the second fixing member 620 may be formed as one integrated body using the same material.

An example of optical switching will now be described with reference to FIG. 7. If light is emitted from the Fresnel lens-integrated optical fiber 601 and the mirror 630 is located as shown in FIG. 7, the light emitted from the Fresnel lens-integrated optical fiber 601 is reflected by the mirror 630 and enters the Fresnel lens-integrated optical fiber 603. That is, the Fresnel lens-integrated optical fibers 601 and 603 are connected via the mirror 630.

Also, when the mirror 630 is rotated 90 degrees clockwise from its position shown in FIG. 7, the Fresnel lens-integrated optical fibers 601 and 607 are connected to each other.

FIG. 8 is a graph showing results of measuring a working distance of a Fresnel lens-integrated optical fiber according to an exemplary embodiment of the present invention.

Measurement of the working distance of the Fresnel lens-integrated optical fiber was carried out by locating a mirror at a predetermined distance from the Fresnel lens surface formed on the longitudinal section of the Fresnel lens-integrated optical fiber, reflecting light emitted from the Fresnel lens surface by the mirror so that it re-enters the Fresnel lens surface of the Fresnel lens-integrated optical fiber, and then measuring the power of the re-entering light.

The graph of FIG. 8 shows a change in optical power corresponding to the separation distance between the Fresnel lens surface of the Fresnel lens-integrated optical fiber according to an exemplary embodiment of the present invention and the mirror. Here, the separation distance having the greatest optical power is defined as the working distance.

Referring to FIG. 8, the working distance of the Fresnel lens surface of the Fresnel lens-integrated optical fiber according to an exemplary embodiment of the present invention is seen to be 550 μm.

As described above, according to a Fresnel lens-integrated optical fiber and a method of fabricating the same, the Fresnel lens-integrated optical fiber includes a light transmission section into which light emitted from a light source or transferred through various optical devices enters and propagates, a light expansion section joined to the light transmission section by fusion splicing and expanding light provided from the light transmission section to a predetermined size, and a Fresnel lens surface formed on a section of the light expansion section by a femtosecond laser or a CO2 laser.

Accordingly, since the Fresnel lens surface performing a lens function has no curvature, arrangement of an optical coupling system is easy and optical coupling efficiency is excellent. Also, since the Fresnel lens surface is integrated into the light expansion section, i.e., the section of a coreless silica fiber, optical coupling loss is small, manufacture is easy, and an optical coupling system can be miniaturized.

While exemplary embodiments of the present invention have been shown and described, it will be appreciated by those skilled in the art that various changes can be made to the described exemplary embodiments without departing from the spirit and scope of the invention defined by the claims and their equivalents.

What is claimed is:

1. A Fresnel lens-integrated optical fiber comprising:
a light transmission section transmitting incident light;
a light expansion section coupled to the light transmission section and expanding light provided from the light transmission section; and
a Fresnel lens surface formed on a section of the light expansion section and focusing by passing through the light expanded in the light expansion section at a predetermined focal length.

2. The Fresnel lens-integrated optical fiber of claim 1, wherein the light transmission section is composed of any one optical fiber selected from a single mode optical fiber, a multi mode optical fiber, a photonic crystal optical fiber, and a hollow optical fiber.

3. The Fresnel lens-integrated optical fiber of claim 1, wherein the light expansion section is composed of any one optical fiber selected from a coreless silica fiber, a GRIN fiber, and a photonic crystal optical fiber with air holes removed.

4. The Fresnel lens-integrated optical fiber of claim 1, wherein the light transmission section and the light expansion section are joined by fusion splicing.

5. The Fresnel lens-integrated optical fiber of claim 1, wherein the Fresnel lens surface is formed in the shape of a Fresnel zone plate composed of odd-numbered and even-numbered zones, and the even-numbered zones are depressed surfaces formed by femtosecond laser-processing or etching the section of the light expansion section.

6. The Fresnel lens-integrated optical fiber of claim 1, wherein the diameter of the light expansion section is formed to be the same as or larger than the diameter of the light transmission section.

7. A method of fabricating a Fresnel lens-integrated optical fiber, comprising:
joining a first optical fiber constituting a light transmission section and a second optical fiber constituting a light expansion section;
cutting the second optical fiber constituting the light expansion section into a predetermined length; and
forming a Fresnel zone plate shape at a section of the second optical fiber.

8. The method of claim 7, wherein in joining the first optical fiber and the second optical fiber, one section of the first optical fiber is joined to one section of the second optical fiber by fusion splicing using arc discharge or a CO2 laser.

9. The method of claim 7, wherein in cutting the second optical fiber, the second optical fiber is cut into a length so that the light expanded in the second optical fiber is not incident on and reflected from the inner circumference of the second optical fiber.

10. The method of claim 7, wherein in forming the Fresnel lens surface, at least one depressed surface, each having a different radius, is formed on the section of the light expansion section.

11. The method of claim 10, wherein the at least one depressed surface is formed by a femtosecond laser or etching.

12. The method of claim 7, wherein the first optical fiber is composed of any one optical fiber selected from a single mode optical fiber, a multi mode optical fiber, a photonic crystal optical fiber, and a hollow optical fiber.

13. The method of claim 7, wherein the second optical fiber is composed of any one optical fiber selected from a coreless silica fiber, a GRIN fiber, and a photonic crystal optical fiber with air holes removed.
